(19) United States
(12) Patent Application Publication
(10) Pub. No.: US 2024/0349941 A1
(43) Pub. Date: Oct. 24, 2024

(54) MULTI-FUNCTIONAL GRIDDLE

(71) Applicant: W.C. Bradley Co.,, Columbus, GA (US)

(72) Inventors: SLEIMAN ABDALLAH, Columbus, GA (US); Mahesh Racha, Columbus, GA (US); Bruce Roberts, Phenix City, AL (US); Jorge Escamilla, Columbus, GA (US); Thomas A. Penner, Columbus, GA (US)

(21) Appl. No.: 18/741,544

(22) Filed: Jun. 12, 2024

Related U.S. Application Data
(60) Provisional application No. 63/472,465, filed on Jun. 12, 2023.
(60) Provisional application No. 63/533,565, filed on Aug. 18, 2023.
(60) Provisional application No. 63/626,124, filed on Jan. 29, 2024.

(51) Int. Cl. A47J 37/06; A47J 37/07

(52) U.S. Cl. CPC A47J 37/0682; A47J 37/0786

(57) ABSTRACT

A cooking griddle having a body, a griddle plate defining at least one versatile section that can be removed, flipped over, or replaced by a secondary cooking member, and a heat source. The versatile sections include a griddle orifice and a sear griddle orifice. Secondary cooking members locate on or in the versatile sections and include a griddle dual side plate having a first side with a non-stick coating and a second side with dimples or ridges, a pizza plate, a wok, a steamer assembly, a member having a perforated surface for allowing flame to char food, a grate, and a lower profile lid. Supports may be provided below the griddle dual side plate in the form of brackets affixed to the griddle plate, a circular ring defining a shelf, and pivoting or extendable brackets. An elevation mechanism elevates a secondary cooking member for allowing air flow.

### CROSS REFERENCE TO RELATED APPLICATIONS

This application claims the priority of U.S. Provisional Patent Application No. 63/472,465 titled “MULTI-FUNCTIONAL GRIDDLE,” filed Jun. 12, 2023, and U.S. Provisional Patent Application No. 63/533,565 titled, “MULTI-FUNCTIONAL GRIDDLE” filed Aug. 18, 2023, and U.S. Provisional Patent Application No. 63/626,124 titled, “DOMED LID LINER” filed Jan. 29, 2024, the contents of each of which are hereby incorporated by reference.

### FIELD OF THE INVENTION

The present invention relates to backyard cooking grills.

### BACKGROUND OF THE INVENTION

Known griddle designs in the market have a solid cooking surface. Known griddle designs have any number of burners, typically from 1 to 6 burners to allow for multiple zones or sections of griddle temperatures. Surface finishes typically are oil coated hot-rolled steel or stainless steel. Stainless steel material is an option used more commonly in commercial griddles.

A current limitation of single use cooking surfaces is that a single use cooking surface does not allow for any other cooking methods or styles except for use as a flat top griddle. While a flat top griddle is fine for cooking burgers, vegetables, rice, and hash browns, it is not conducive to cooking pizza, noodles, soups, stews, or deep frying in oil. Additionally, a top surface of uncoated griddle surfaces is normally oily and has a layer of food residue that would not be desirable on the crust of a pizza.

Another limitation is that nearly all griddles do not have a lid. If they have a cover, they are normally not designed to be used as an oven or enclosure for cooking. They are merely designed for storage to prevent dirt and animal droppings from landing on the cooking surface.

Current outdoor cookers of various fuel types may have no liner or insulating layer in any provided lid. Some utilize liners of a thin gauge steel that may be positioned close to the outer shape/surface/contour of the lid. An air gap of 6-19 mm between the liner and lid center panel may be maintained in some cases.

Some lid liners help insulate the cooking chamber and prevent the discoloration of a stainless steel outer panel. The space or gap between the liner and the outer lid can provide a protective barrier between the hot cook chamber and the cooler ambient temperatures outside. However, limitations for this construction include the fact that such a liner does not provide or return much radiant energy to the food, nor do they provide any convective circulation. Heat, moisture, and smoke that may be generated during the cooking process simply flows away from the food and out the flue exhaust opening. Therefore, the functional benefit of the lid liner is limited to just temperature insulation. Moreover, the insulative properties of prior art liners may be less than optimal.

What is needed is a system and method for addressing the above, and related, issues.

### SUMMARY OF THE INVENTION

The griddle of the invention has versatile sections of a flat top griddle that can be removed, flipped over, or replaced by a secondary cooking surface or vessel such as a pizza plate, sear plate, wok, steamer, or perforated surface to allow the flames from the heat source to char the food. None of these options are currently possible with a flat-top, solid steel, cooking surface.

With the use of a low profile lid, specifically designed to be used over food, the griddle can become an oven for baking items such as a pizza, cookies, or a searing zone to cook steaks or such at higher temperatures.

By changing a section or panel of the flat top griddle surface to a pizza plate or a clean surface, and utilizing the functional lid, cooks/chefs have the ability to bake a pizza or cookies without imparting an oily or undesirable taste in the food. Removal of the section would leave an opening in the cook surface to allow direct access to the heat source. This opening could accept a new cook vessel such as a wok for boiling noodles or even deep frying potatoes or hush puppies. An additional cooking vessel could be a steamer to steam cook vegetables. If desired, a perforated steel plate or a cast iron grid could be used to fill the open that would allow for grilling and searing steaks. The versatility of cooking methods possible allow for a consumer to have limitless food preparation options.

The surface of the pizza plate may have dimples or ridges to elevate the pizza for a different crust texture, to keep the crust from sticking to the plate, to promote air circulation around the dough, and to prevent sogginess in the center of the crust. The griddle will have a variety of cutout openings with different shapes—such as rectangular opening for sear zone and steamer zone or round opening for pizza plate or cooking with a wok. The mounting of the pizza plate could be on support or resting tabs that elevate the entire plate thus allowing for air flow or flue gas circulation around the perimeter of the pizza plate.

Another asset of this invention is to provide a drawer or chamber under the burners that could be used for broiling food. Access to this chamber may be from the front or side and operate in a manner similar to a pull out drawer with a depth sufficient to load a pan or grate of food items. In this way, cooking may be conducted with a heat source above the food rather than the typical method with a heat source below the food.

### BRIEF DESCRIPTION OF THE DRAWINGS

FIG. 1 is a perspective view of the griddle of the multi-functional griddle of the invention;

FIG. 2 is a plan view of a griddle surface with pizza griddle dual side plate installed with a pizza surface facing up and sear griddle dual side plate installed with a sear surface facing up in the multi-functional griddle of FIG. 1;

FIG. 3 is a plan view of a griddle surface with pizza griddle dual side plate installed with a pizza surface facing up and sear griddle dual side plate installed with a sear surface facing up in the multi-functional griddle of FIG. 1;

FIG. 4 is a plan view of a griddle surface with pizza griddle dual side plate and sear griddle dual side plate removed in the multi-functional griddle of FIG. 1;

FIG. 5 is a plan view of a griddle surface with pizza griddle dual side plate and sear griddle dual side plate installed with a griddle surface facing up in the multi-functional griddle of FIG. 1;

FIG. 6 is a perspective view of the multi-functional griddle of FIG. 1 showing secondary cooking vessels installed in the form of a wok and steamer assembly;

FIG. 7 is an elevation cut-away view of the wok of FIG. 6;

FIG. 8 is an exploded perspective view of the steamer assembly of FIG. 6;

FIG. 9 is a plan view of a top surface of a griddle plate of the multi-function griddle of FIG. 1 showing fixed mounting attachments;

FIG. 10 is a plan view of a bottom surface griddle of the multi-function griddle of FIG. 1 showing fixed mounting attachments;

FIG. 11 is a plan view of a bottom surface griddle of the multi-function griddle of FIG. 1 showing fixed mounting attachments having a circular ring welded to the griddle plate;

FIG. 12 is an enlarged perspective view of a bottom surface griddle of the multi-function griddle of FIG. 11 showing fixed mounting attachments having a circular ring welded to the griddle plate;

FIG. 13 is a perspective view of the circular ring of FIGS. 11 and 12;

FIG. 14 is a plan view of a top surface of a griddle plate of the multi-function griddle of FIG. 1 with rotary brackets in an extended configuration;

FIG. 15 is an enlarged perspective view of a bottom surface of the griddle plate of FIG. 14 showing a rotary bracket in a retracted configuration;

FIG. 16 is a plan view of a top surface of a griddle plate of the multi-function griddle of FIG. 14 with rotary brackets in a retracted configuration;

FIG. 17 is a perspective view of a bottom surface of the griddle plate of FIG. 14 showing a sliding bracket in an extended configuration;

FIG. 18 is a perspective cut-away view of a sliding bracket of FIG. 17 shown in an extended configuration;

FIG. 19 is a perspective view of a bottom surface of the griddle plate of FIG. 17 showing sliding brackets in a retracted configuration;

FIG. 20 is a plan view of the griddle plate of FIG. 1 with the pizza griddle dual side plate removed and a round burner visible;

FIG. 21 is a perspective view of the griddle plate of FIG. 1 with the pizza griddle dual side plate removed and an elevation mechanism bracket visible;

FIG. 22 is an enlarged perspective view of the elevation mechanism bracket of FIG. 21 shown in a lower position;

FIG. 23 is a perspective view of the griddle plate with a pizza griddle dual side plate installed in a lower or flush configuration;

FIG. 24 is an enlarged perspective view of the elevation mechanism bracket of FIG. 21 shown in an upper position;

FIG. 25 is a perspective view of the griddle plate with a pizza griddle dual side plate installed in an upper or raised configuration;

FIG. 26 is an exploded perspective view of the pizza griddle dual side plate, and elevation mechanism circular ring and the pizza griddle orifice of the griddle plate;

FIG. 27 is a perspective view of the circular ring of FIG. 26;

FIG. 28 is a perspective view of a bottom surface of the griddle plate wherein the pizza griddle dual side plate is received in the circular ring of FIG. 26;

FIG. 29 is a perspective view of a top surface of the griddle plate wherein the pizza griddle dual side plate is received in the circular ring of FIG. 26 in a flush configuration;

FIG. 30 is a cross sectional view of the circular ring of FIG. 26 on a support affixed to a bottom surface of the griddle plate wherein the pizza griddle dual side plate in an elevated configuration with respect to a top surface of the griddle plate;

FIG. 31 is a perspective view of a top surface of the griddle plate wherein the pizza griddle dual side plate is received in the circular ring of FIG. 26 in an elevated configuration;

FIG. 32 is a front perspective view of an embodiment of the griddle of the multi-functional griddle of the invention of FIG. 1 having a grease drain and drawer assembly;

FIG. 33 is a rear perspective view of the griddle of FIG. 32 having a grease tray assembly installed on a rear surface of the body of the multi-functional griddle;

FIG. 34 is a front perspective view of an embodiment of the griddle of the multi-functional griddle of the invention of FIG. 1 having a grease drain and a single griddle orifice, i.e., the sear griddle dual side plate;

FIG. 35 is a cut-away view of the multi-functional griddle of the invention of FIG. 33 showing a grease duct for transferring grease from the grease drain into the grease tray assembly and a deep drawer received in a front surface of the body of the multi-functional griddle;

FIG. 36 a cut-away view of the multi-functional griddle of the invention of FIG. 33 showing a grease duct for transferring grease from the grease drain into the grease tray assembly and a shallow drawer received in a front surface of the body of the multi-functional griddle.

FIG. 37 is a perspective view of the multi-functional griddle of the invention of FIG. 6 showing secondary cooking members in form of a standard cooking grate received in the round pizza griddle orifice and charcoal pan with grate option received in the rectangular sear griddle orifice;

FIG. 38 is a perspective view of the griddle plate and various secondary cooking options in the form of example grate options for being received in the round pizza griddle orifice and example rectangular insert options for being received in sear griddle orifice;

FIG. 39A is an elevation view of a grease tray for locating below a fire box of the multi-functional griddle of FIG. 1;

FIG. 39B is a plan view of an upper surface of the grease tray of FIG. 39A with a drain;

FIG. 39C is a plan view of a lower surface of the grease tray of FIG. 39A shown without a grease cup receiver adjacent to the drain;

FIG. 39D is a perspective view of the grease tray of FIG. 39A shown with a grease cup receiver adjacent to a drain and a grease cup for installation in grease cup receiver;

FIG. 40A is a perspective view of a removable warming rack;

FIG. 40B is a side elevation view of a removable warming rack;

FIG. 40C is a side elevation view of a removable warming rack shown installed on a griddle plate of the multi-functional griddle of FIG. 1;

FIG. 41A is a perspective view of multi-functional griddle with a door and pull out drawer/grate in a lower cooking chamber;

FIG. 41B is a perspective view of the multi-functional griddle of FIG. 41A with a door and pull out drawer/grate in a lower cooking chamber;

FIG. 42A is a plan view of a pizza griddle plate having a dimple design;

FIG. 42B is a perspective view of the pizza griddle plate of FIG. 42A;

FIG. 43 is a plan view of an alternate griddle surface design having dimples and searing ridges;

FIG. 44A shows a cooking grate placed on a cooking grill and elevated of a cooking grill;

FIG. 44B shows a cooking grate placed directly on a cooking grill;

FIG. 45 is a right perspective view of a domed lid liner installed in a griddle according to aspects of the present disclosure;

FIG. 46 is a front perspective view of the domed lid liner and griddle of FIG. 45;

FIG. 47 is a left perspective view of the domed lid liner and griddle of FIG. 45.

### DETAILED DESCRIPTION OF THE PREFERRED EMBODIMENTS

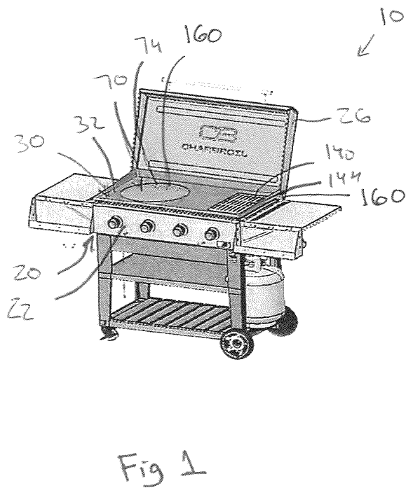

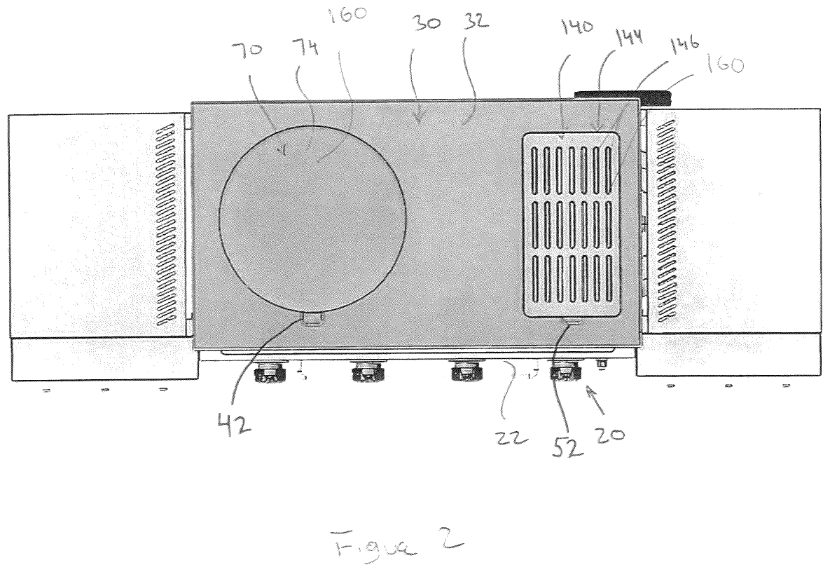

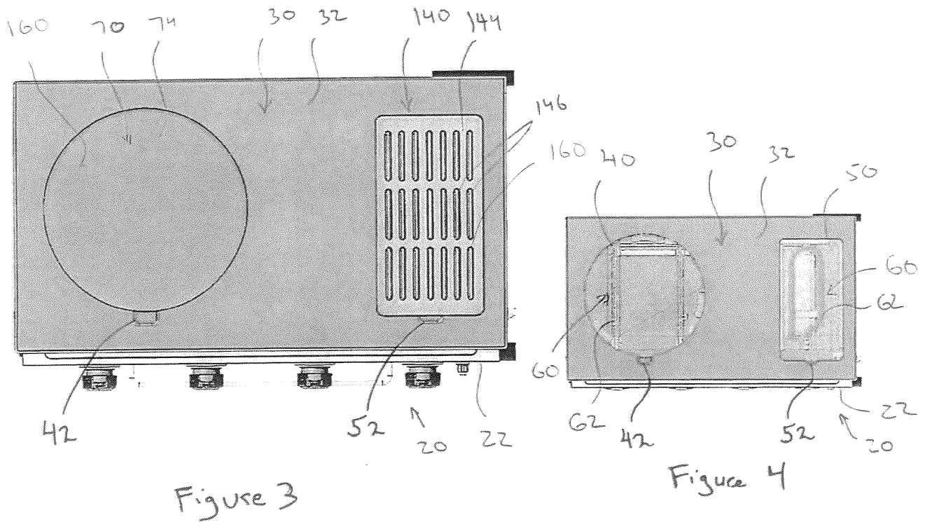

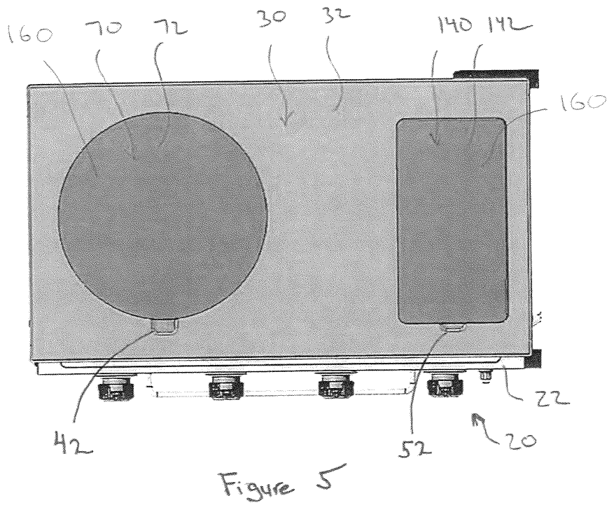

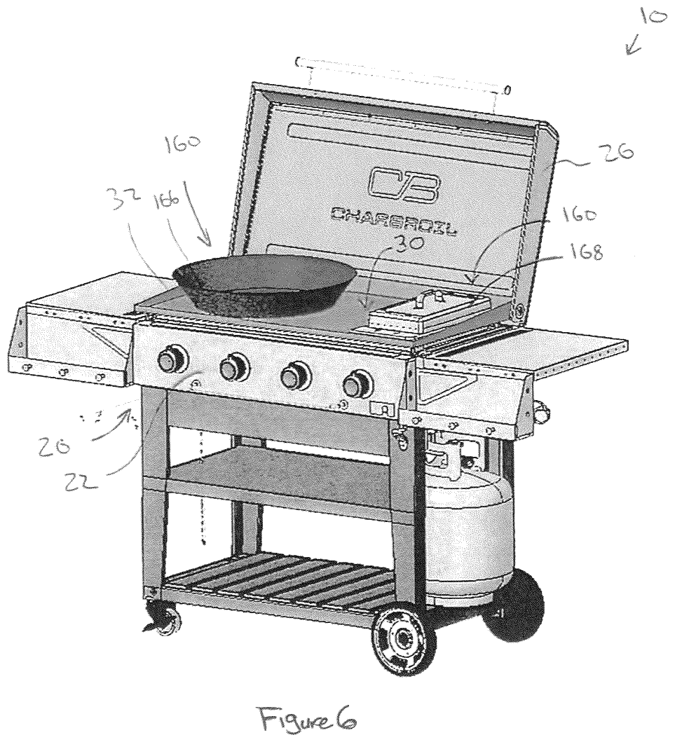

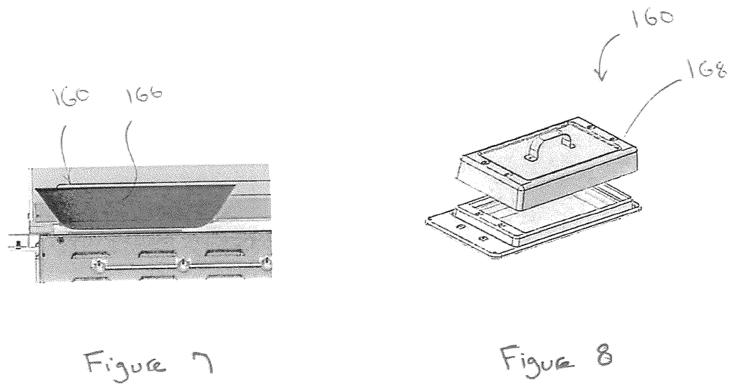

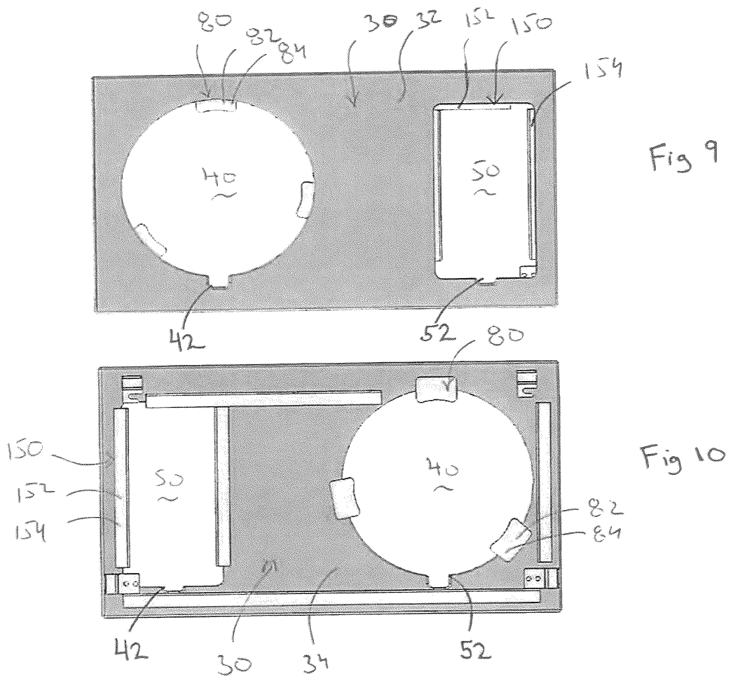

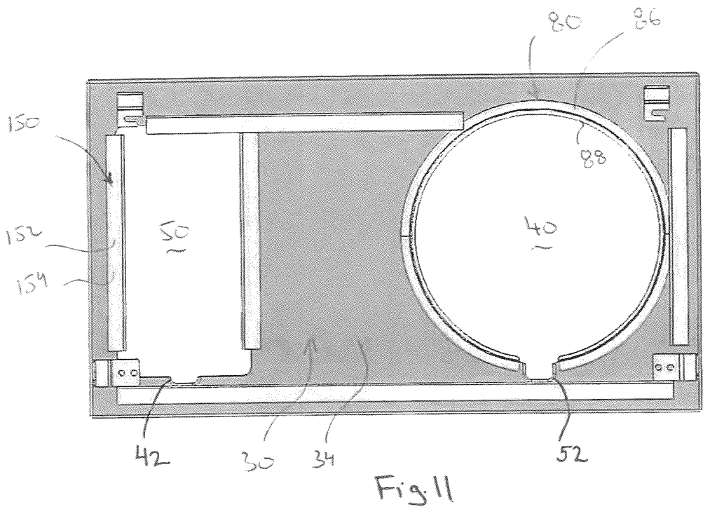

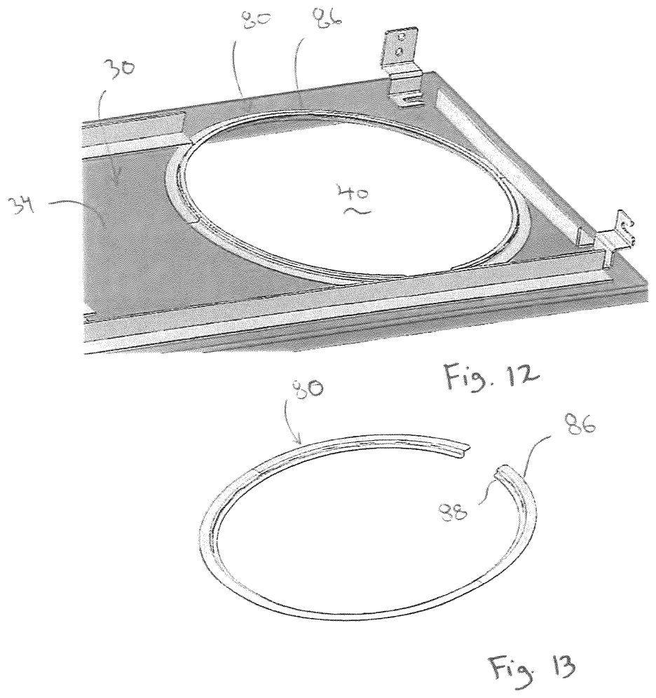

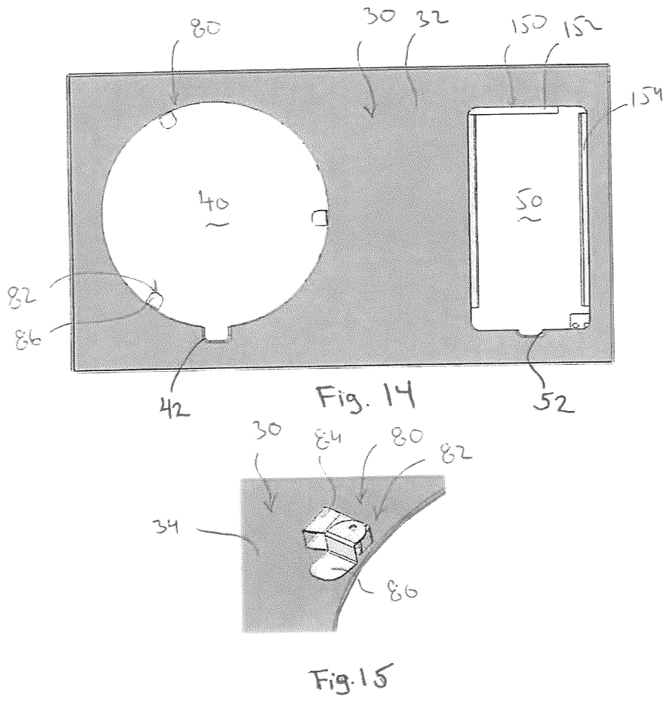

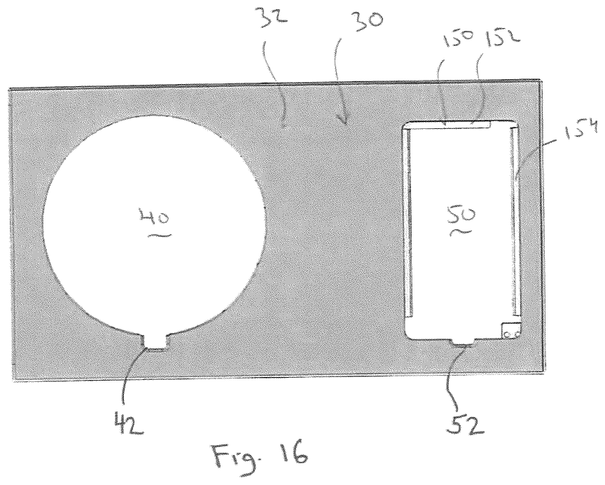

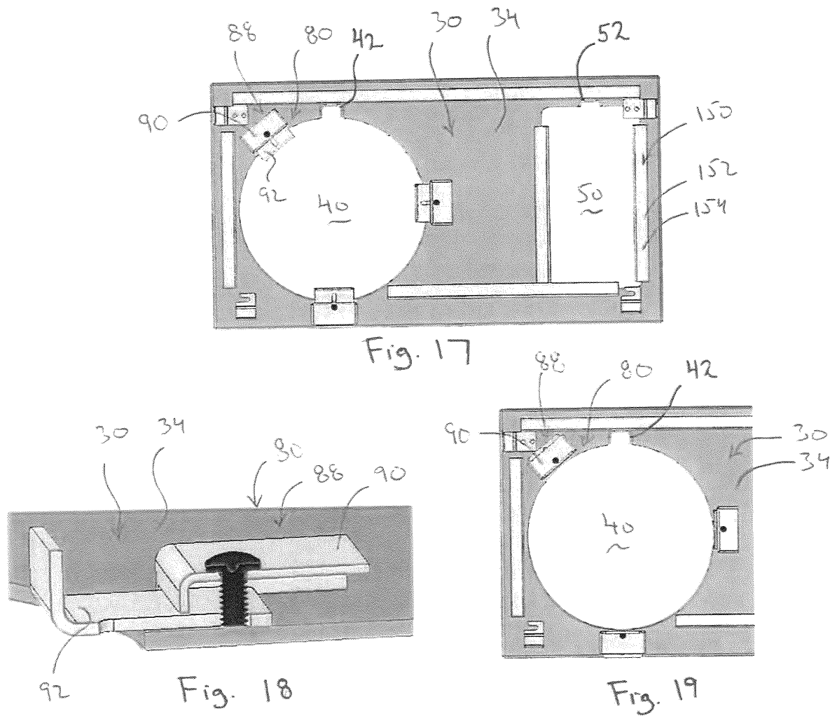

Referring to FIG. 1, shown is a cooking griddle designated generally 10. Cooking griddle 10 includes body 20. Body 20 has front surface 22, and rear surface 24. Lid 26 is hingedly affixed rear surface 24 of body 20.

Body 20 supports griddle plate 30. Griddle plate 30 defines griddle surface 32, bottom surface 34 and grease drain 36. Griddle plate 30 additionally defines pizza griddle orifice 40. Adjacent to pizza griddle orifice 40, griddle plate 30 defines cutout 42 for grease drainage and/or to provide access for tool insertion to move or flip objects located in pizza griddle orifice 40, such as pizza griddle dual side plate 70. In one embodiment, pizza griddle orifice 40 is round and defines a center and a radius. Griddle plate 30 further defines sear griddle orifice 50. In one embodiment, sear griddle orifice 50 is rectangular. Adjacent to sear griddle orifice 50, griddle plate 30 defines cutout 52 for grease drainage and/or to provide access for tool insertion to move or flip objects located in pizza griddle orifice 40, such as sear griddle dual side plate 140.

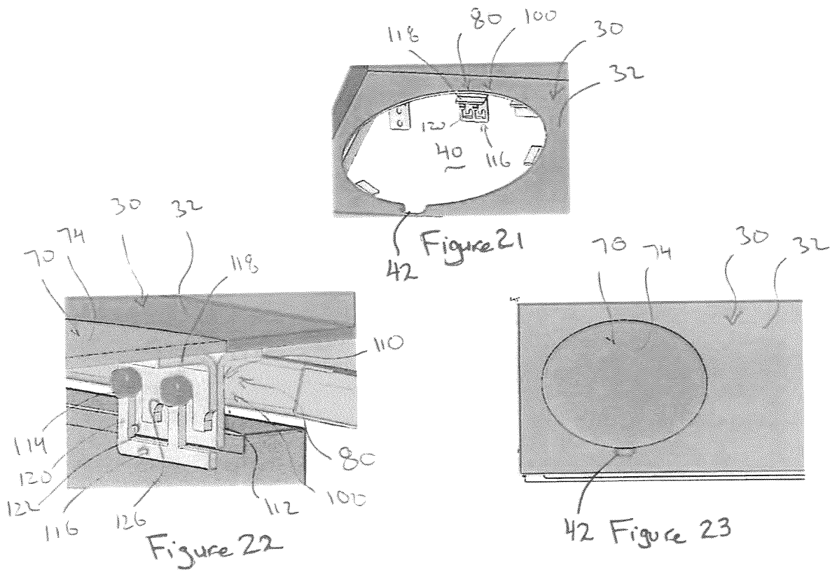

Heat source 60 is below griddle plate 30. In one embodiment, heat source 60 is a burner 62. In one embodiment, burner 62 is below pizza griddle orifice 40. In one embodiment burner 62 has a round portion 64 (FIG. 20) having a center co-located with the center of pizza griddle orifice 40. Round portion 64 preferably has a radius that is smaller than the radius of pizza griddle orifice 40.

Pizza griddle dual side plate 70 (see, e.g., FIG. 2) sized to be received in pizza griddle orifice 40. Pizza griddle dual side plate 70 defines a perimeter and has a griddle side 72 and a pizza plate side 74, wherein pizza griddle dual side plate 70 is received in pizza griddle orifice 40.

In one embodiment, pizza plate side 74 is covered with a non-stick coating. In one embodiment, pizza plate side 74 defines dimples or ridges to elevate, e.g., a pizza for creating a different crust texture or to keep crust from sticking to pizza plate side 74 of pizza griddle dual side plate 70.

In one embodiment, pizza griddle dual side plate 70 rests on supports 80 below griddle plate 30 that are capable of extending into pizza griddle orifice 40 (see, e.g., FIGS. 9-15). In one embodiment, supports 80 are brackets 82 that are affixed to bottom surface 34 of griddle plate 30 for extending into pizza griddle orifice 40. In one embodiment, brackets 82 are fixed. For example, brackets 82 are tabs 84. In one embodiment, tabs 84 are welded to bottom surface 34 of griddle plate 30. In one embodiment, supports 80 are circular ring 86 defining interior shelf 88.

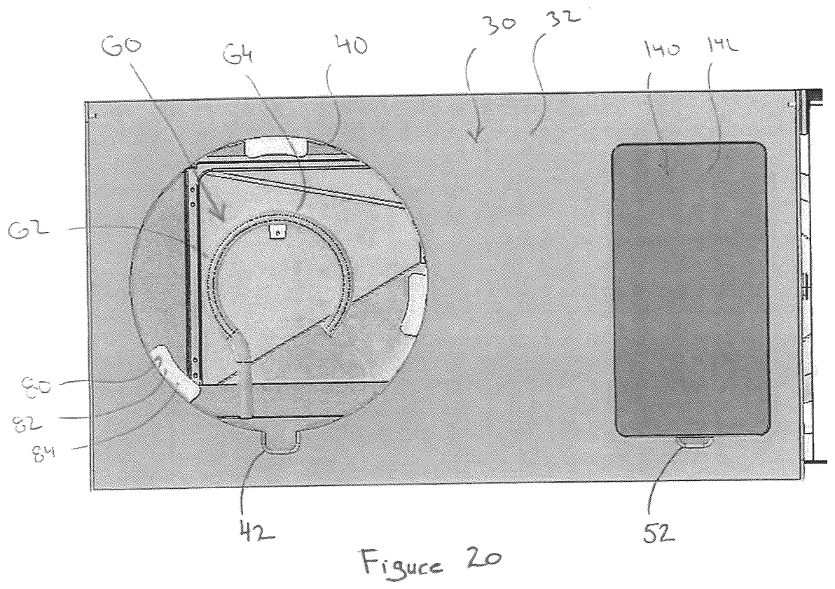

In one embodiment, the supports 80 are adjustable. For example, in one embodiment, supports 80 are a pivotal bracket 82 (FIGS. 14, 15) having a base 84 and a pivotally mounted tab 86 for selectively extending into pizza griddle orifice 40. In one embodiment, supports 80 are an extendable bracket 88 (FIGS. 17-19) having base 90 and extendable mounted tab 92 for selectively extending into the pizza griddle orifice 40.

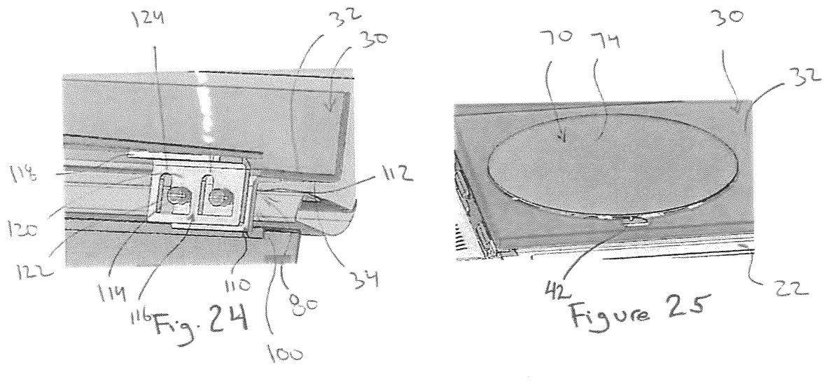

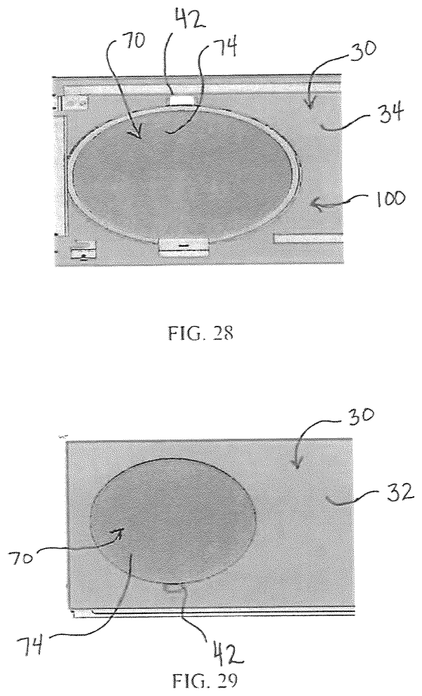

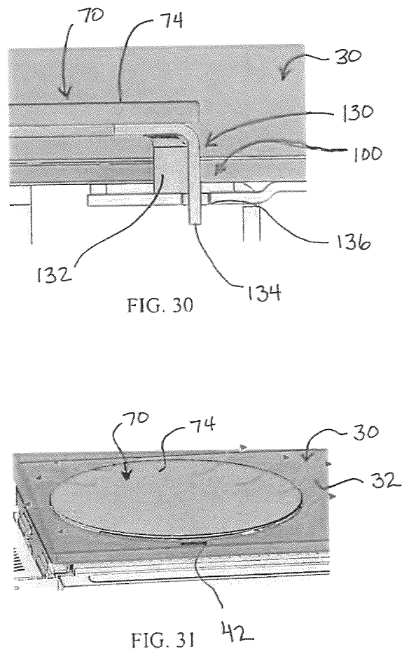

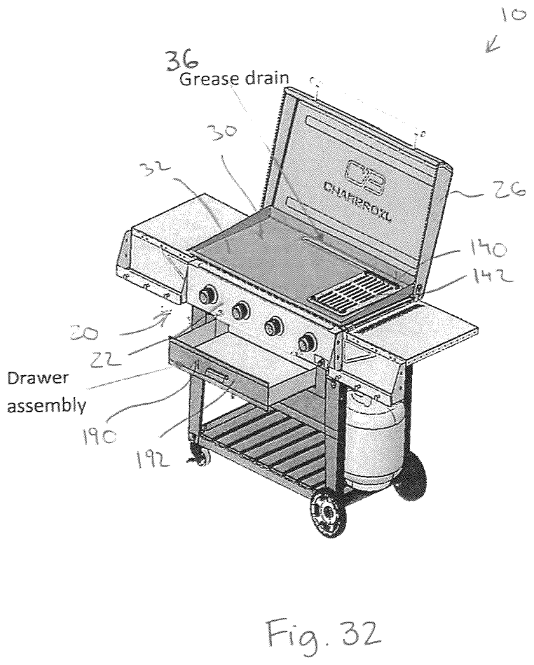

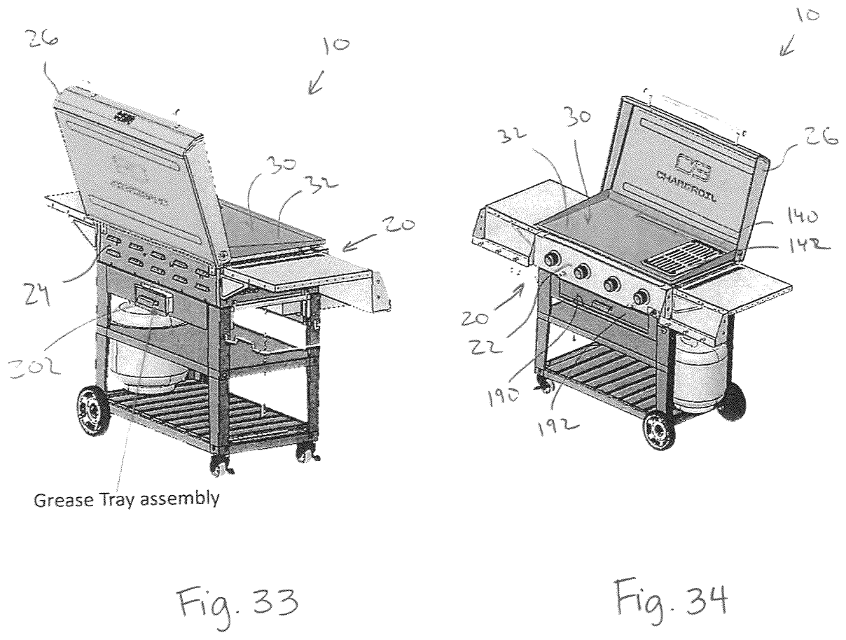

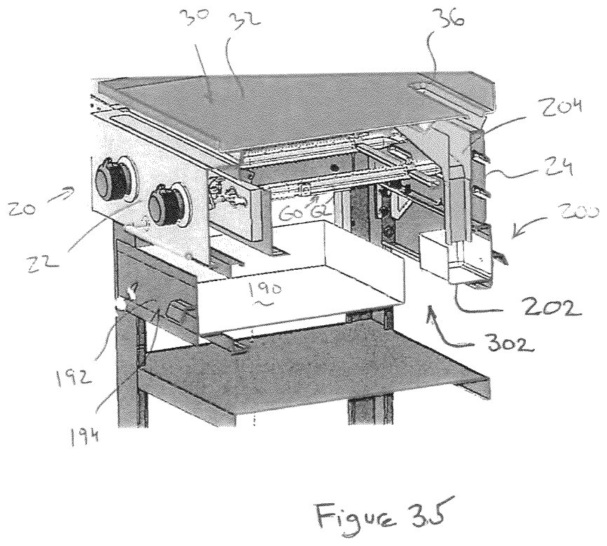

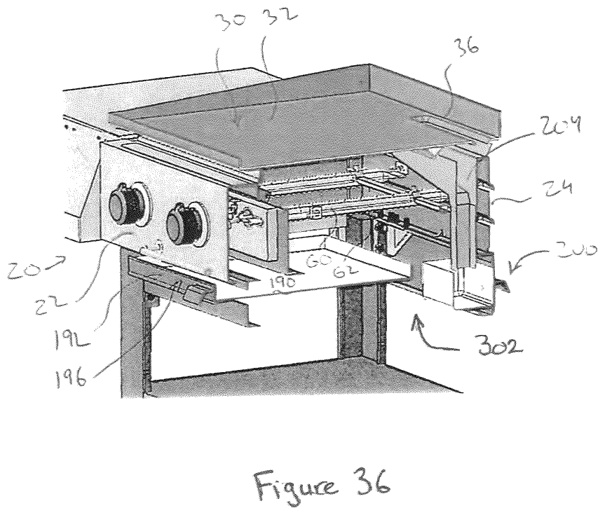

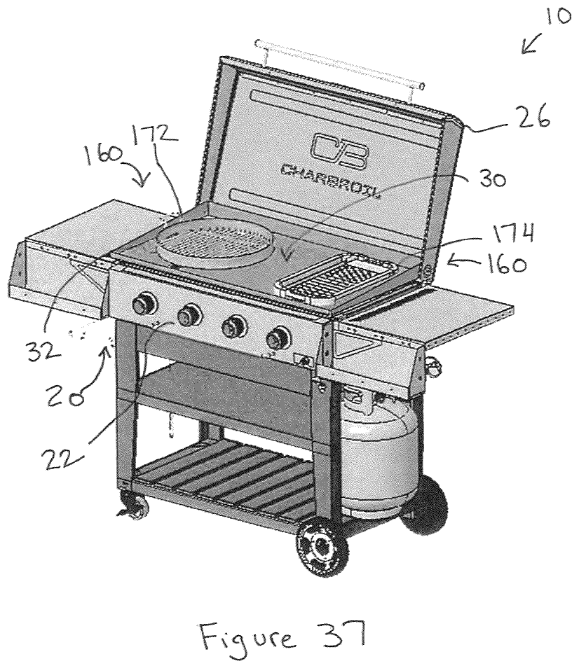

Referring now to FIGS. 21-31, elevation mechanism 100 may be provided for elevating pizza griddle dual side plate 70 for allowing air flow or flue gas circulation around the perimeter of the pizza griddle dual side plate 70. In one embodiment, elevation mechanism 100 includes griddle support member 110 (FIGS. 21, 22, 24) having vertical portion 112 and protruding member 114. Elevation mechanism 100 further includes plate support member 116 defining horizontal plate support portion 118, a vertical portion 120 having a shaped orifice 122 that defines a lower position terminus 124 and an upper position terminus 126 (see, e.g., FIG. 22). Plate support member 116 may be manipulated to receive protruding member 114 in lower position terminus 124 (FIG. 22) for locating pizza griddle dual side plate 70 at a position flush with griddle surface 32 of griddle plate 30. Plate support member 116 may be manipulated to receive protruding member 114 in upper position terminus 126 (FIG. 24) for locating pizza griddle dual side plate 70 at an elevated position with respect to griddle surface 32 of griddle plate 30 for permitting hot air to escape around the perimeter of pizza griddle dual side plate 70 to enhance cooking. In one embodiment, the elevated position is 2 mm to 10 mm above pizza griddle surface 74. In one embodiment the elevated position is 4 mm to 8 mm above pizza griddle surface 74. In one embodiment the elevated position approximately 6 mm above pizza griddle surface 74.

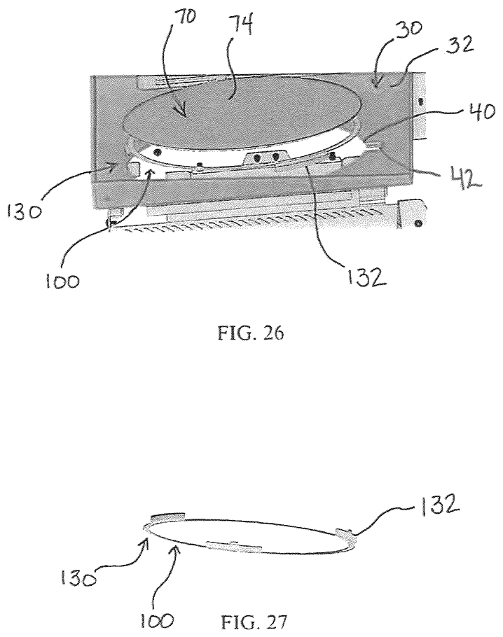

In one embodiment, elevation mechanism 100 includes circular elevation ring 130 (FIGS. 26-31) defining a plurality of downwardly extending elevation tabs 132. Circular elevation ring 130 may be rotationally oriented to locate elevation tabs 132 away from supports 80 thereby facilitating a flush relationship of one of surfaces 72, 74 of pizza griddle dual side plate 70 and griddle surface 32 (see, e.g., FIG. 29). Circular elevation ring 130 may be rotationally oriented such that elevation tabs 132 are resting on supports 80, thereby facilitating an elevated position of one of surfaces 72, 74 of pizza griddle dual side plate 70 with griddle surface 32 of griddle plate 30 (see, e.g., FIG. 31). In one embodiment, the elevated position is 2 mm to 10 mm above griddle surface 32. In one embodiment, the elevated position is 4 mm to 8 mm above griddle surface 32. In one embodiment, the elevated position is approximately 6 mm above griddle surface 32. In one embodiment, elevation tabs 132 define a location protrusion 134 and wherein supports 80 define location orifice 136. Locating location protrusion 134 in location orifice 136 maintains circular elevation ring 130 in a desired rotational orientation (see e.g., FIG. 31).

Sear griddle dual side plate 140 is sized to be received in the sear griddle orifice 50. Sear griddle dual side plate 140 defines griddle surface side 142 and sear mark side 144 defining sear mark ridges 146.

Sear griddle dual side plate 140 is supported on supports 150 below griddle plate 30. Supports 150 extend into sear griddle orifice 50. Supports 150 are brackets 152 that are welded to bottom surface 34 of griddle plate 30. In one embodiment, brackets 152 are longitudinal members 154.

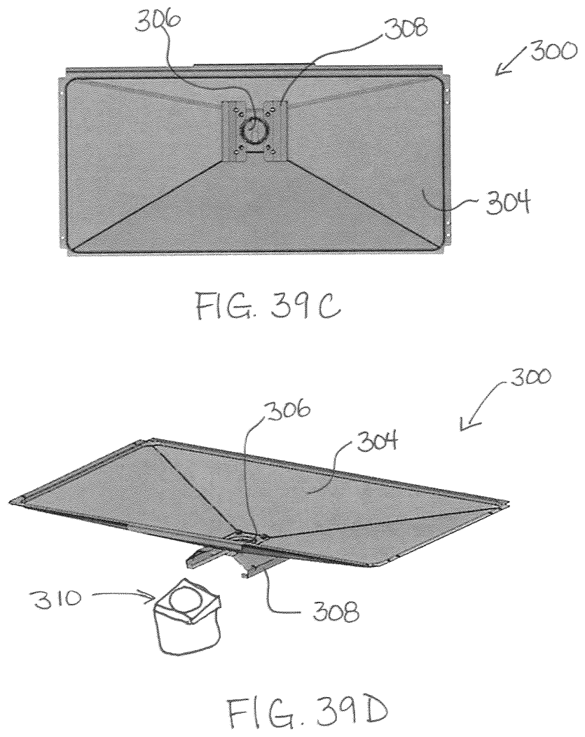

Secondary cooking member 160 may be provided to be received in pizza griddle orifice 40 or sear griddle orifice 50. In one embodiment, secondary cooking member 160 is a pizza plate 162 for being received in pizza griddle orifice 40. In one embodiment secondary cooking member 160 is a sear plate 164 for being received in sear griddle orifice 50. In one embodiment, secondary cooking member 160 is wok 166 is for being received in pizza griddle orifice 30. In one embodiment, wok 166 is sized to extend below griddle surface 32 when received in pizza griddle orifice 30 for increasing captured convection. In one embodiment, secondary cooking member 160 is steamer assembly 168 (FIG. 6) for being received in sear griddle orifice 50. In one embodiment, secondary cooking member 160 is perforated surface 170 to allow flames from a heat source 60 to char food. Secondary cooking member 160 may be standard cooking grate 172 (FIG. 37) sized to be received in round pizza griddle orifice 40 or charcoal pan with grate option 174 for being received in sear griddle orifice 50 (FIG. 37). Other options for secondary cooking member 160 include grate options 176 (FIG. 38) for being received in round pizza griddle orifice 40, for example, precision flame IR grate 176a, cast Q IR Grate 176b, charcoal pan and grate 176c, and convective grate 176d. Additional options for secondary cooking member 160 include rectangular insert options 178 (FIG. 38) for being received in sear griddle orifice 50, for example, precision flam IR grate 178a, charcoal pan and grate 178b, cast Q IR grate 178c, and convective grate 178d. Additionally round or rectangular versions of each of the above listed secondary cooking members 160 may be located in an opposite one of round pizza griddle orifice 40 or sear griddle orifice 50, as desired.

A lower profile lid 180 may be provided for covering a surface of griddle plate 30 to create an oven for baking items such as a pizza, cookies, or a searing zone, e.g., to cook steaks at a higher temperature.

Compartment 190 may be provided under heat source 60 for warming or broiling food. In one embodiment, compartment 190 is drawer 192. In one embodiment, drawer 190 is received in front surface 22 of body 20. In one embodiment, drawer 192 is deep drawer 194 having a front, a rear, and sides that are 3-5 inches in height. Deep drawer 194 is for warming contents of deep drawer 194. In one embodiment, drawer 192 is shallow drawer 196 having a front, a rear, and sides that are 0 to 3 inches in height. Shallow drawer 196 is for broiling contents of shallow drawer 196.

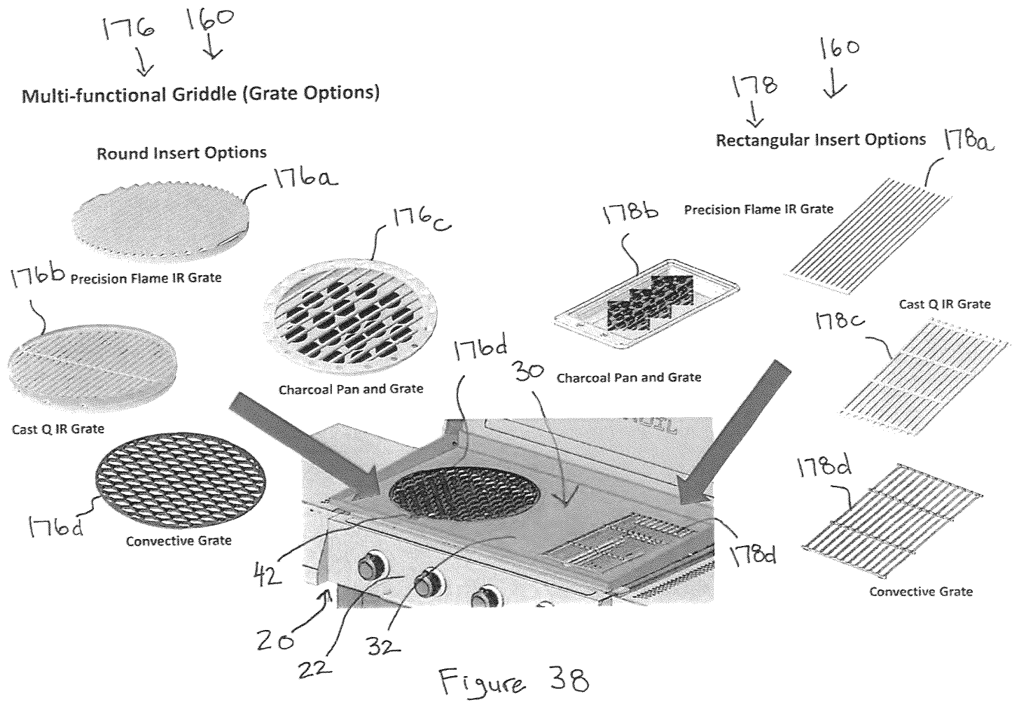

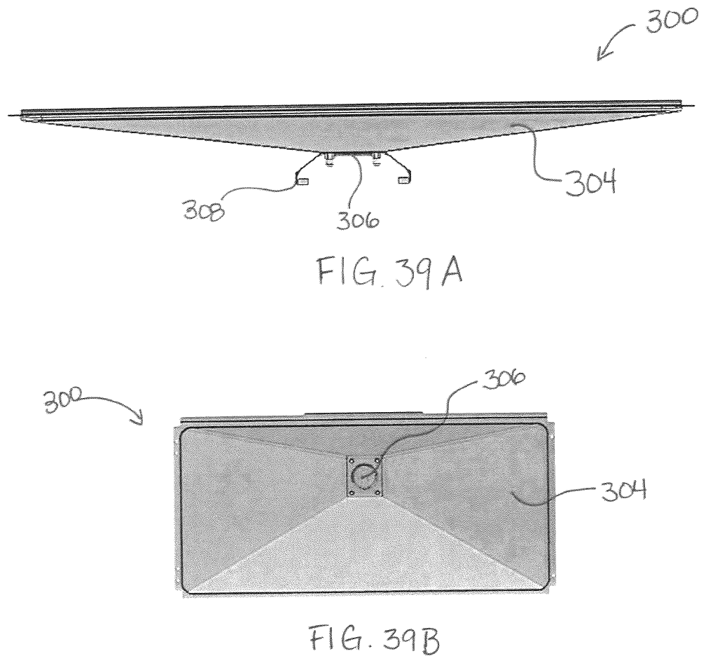

Referring to FIGS. 35 and 36, grease tray assembly 200 is below grease drain 36 of griddle plate 30. Grease tray assembly 200 includes grease drawer 202 (FIG. 33) received in rear surface 24 of body 20. Grease drawer 202 receives grease from grease duct 204 that receives grease from grease drain 36 and directs the grease to grease drawer 202. Grease drain 36 and associated grease duct 204 are shown with an exemplary placement adjacent a rear edge of griddle plate 30. However grease drain 36 and associated grease duct 204 may be located adjacent a front edge, left edge, right edge, rear edge, centered along an edge or asymmetrically located adjacent an edge, as well as being located at a center or other location on griddle plate 30.

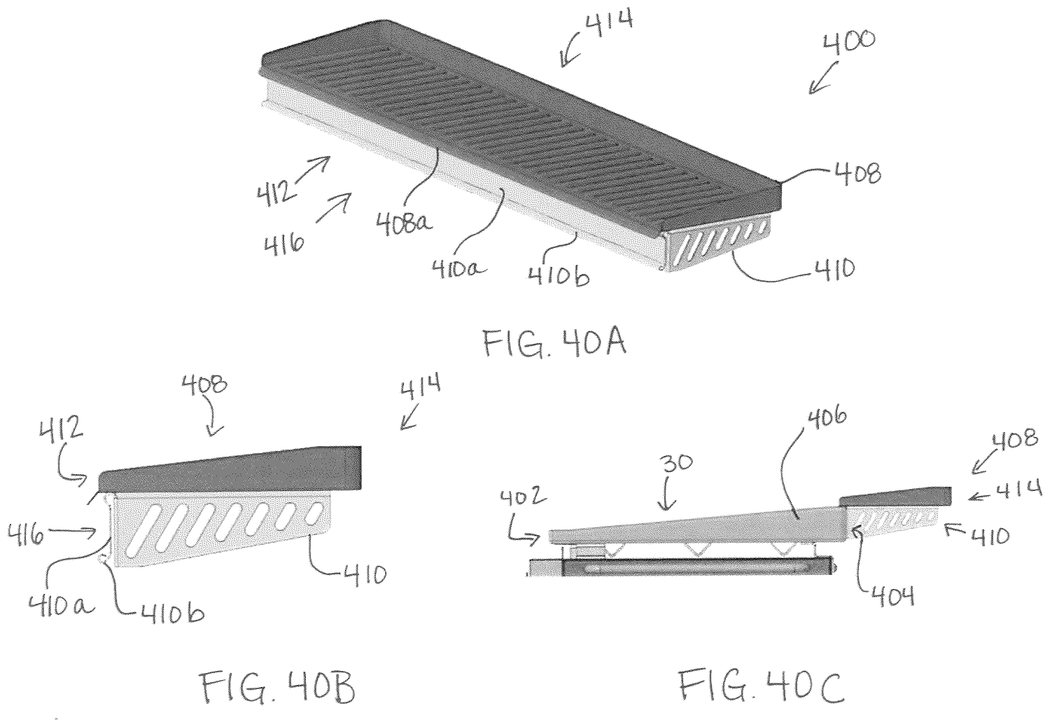

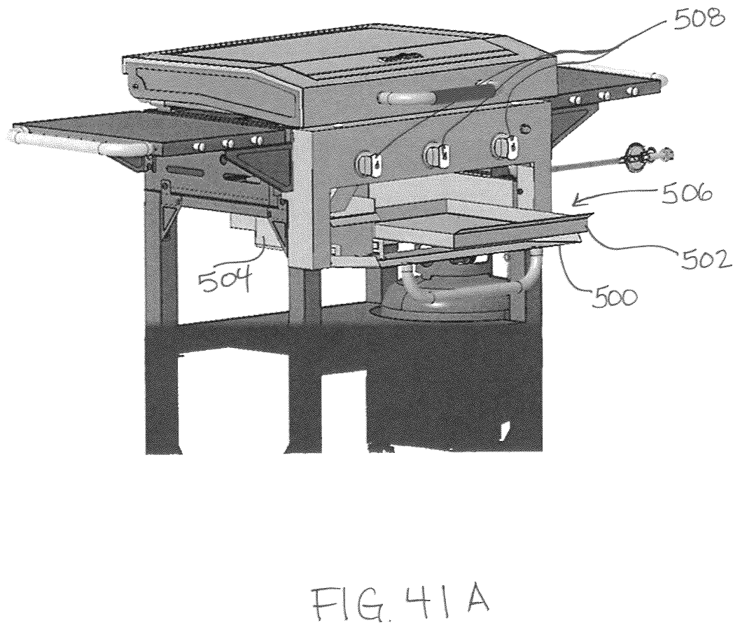

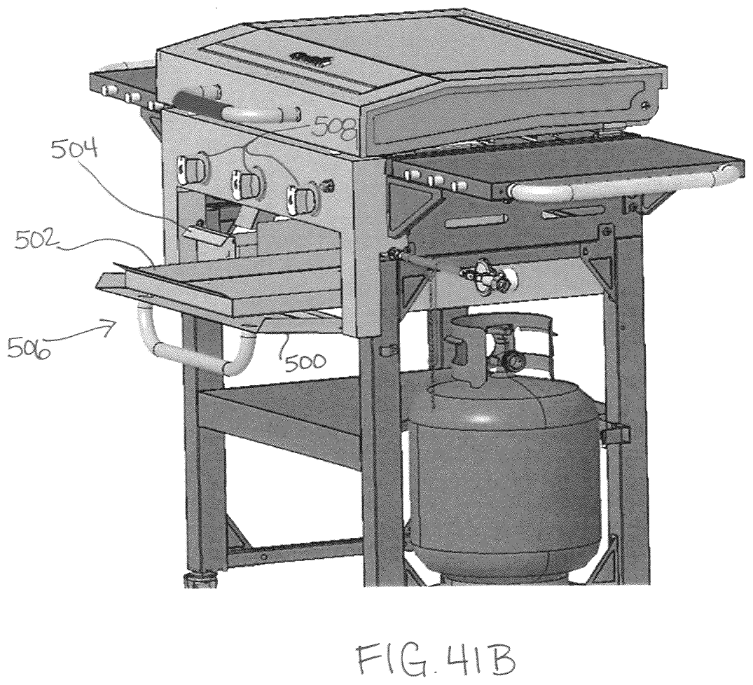

In one embodiment, grease tray 300 (FIGS. 39A-39D) is located below griddle plate 30 and below heat source 60, e.g., burner 62, in fire box 302 (FIGS. 35, 36). Grease tray 300 is preferably removable for cleaning. Grease tray 300 preferably has a shaped surface 304 to direct grease towards grease tray drain 306. Grease cup receiver 308 may be provided on a lower side of shaped surface 304 to optionally receive a grease cup 310 (FIG. 36D), i.e., grease cup 310 is removable suspended from grease cup receiver 308 on bottom of the grease tray 300.

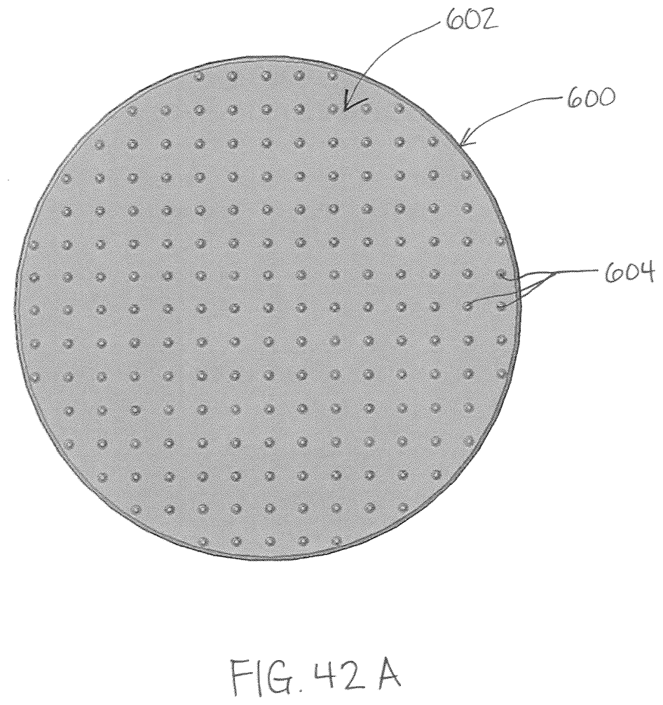

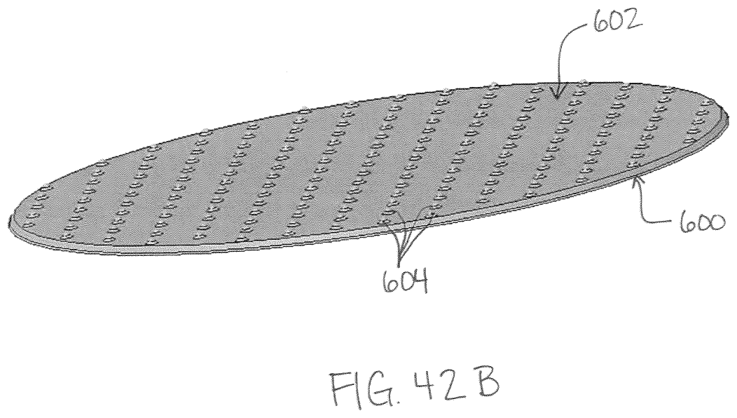

In one embodiment, a clip-on warming rack 400 (FIGS. 40A-40C) may be provided for removably securing to griddle plate 30. Preferably, griddle plate 30 has a front side 402 and a rear side 404 (FIG. 40C). Griddle plate 30 may be at least partially surrounded by wall 406 (FIG. 40C). Clip on warming rack 400 has a warming rack section 408 and base section 410 and defines an engaging side 412 and an outer side 414. Warming rack section 408 preferably defines warming rack upper lip 408a that protruded outward on engaging side 412. Base section 410 preferably includes clip member 410a that defines lower lip 410b. Clip-on warming rack 400 may be provided with a clip-on assembly 412 for removably securing clip-on warming rack 400 to wall 406 of griddle plate 30. In one embodiment, clip-on assembly 416 includes upper lip 408a for engaging a top surface of wall 406 and lower lip 410b for resting against an outer surface of wall 406. Preferably, clip-on warming rack 400 is installed in a non-lidded embodiment of cooking griddle 10.

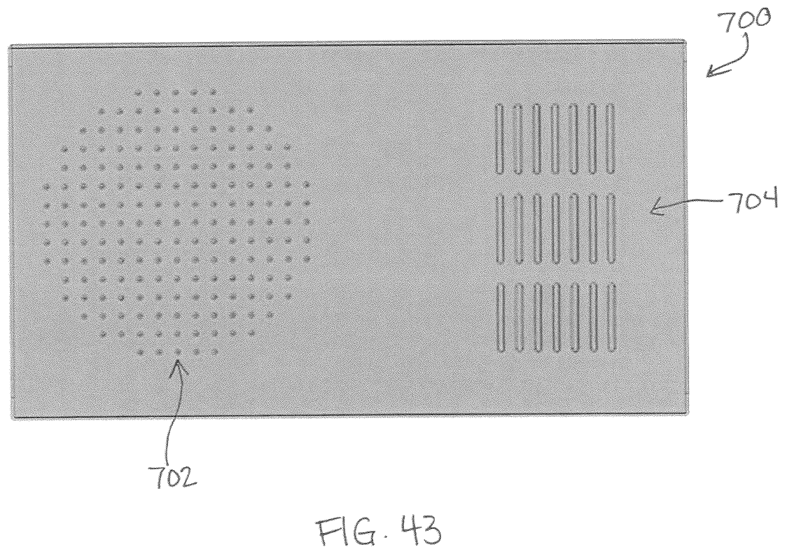

In one embodiment, door 500, (FIGS. 41A, 41B) pull-out drawer/grate 502, and grease cup 504 provide access to lower cooking chamber 506 below griddle burners 62 and firebox 302 (FIGS. 35, 36). In one embodiment, cooking chamber 506 is located below griddle firebox 302 and is heated from above by griddle burner system, e.g., burners 62, located between cooking chamber 506 and griddle cooking surface 32. Cooking chamber 506 may use one upper griddle burner, e.g., burner 62, or multiple upper griddle burners. Control valves 508 for griddle burners 62 may be used to control heat to cooking chamber 506. Control valves 508 can preferably be controlled independently and set by a user.

Additionally, control valves 508 for griddle burners 62, used to heat cooking chamber 506, can be controlled in series using a separate thermostatically controlled gas valve (e.g., the Winners system). For example, when the user selects a temperature control mode, the thermostatically controlled gas valve will supply gas flow to cooking chamber burners 62 using temperature feedback from a temperature probe that may be located in cooking chamber 506 or may be located in an area near gas burners 62 and firebox 302. The thermostatically controlled gas valve will vary the gas flow rate to maintain the control temperature that is selected by the user.

Cooking chamber 506 may also be heated by a separate burner or burners controlled by a separate control valve or valves independent of the griddle burners 62. These separate burners may be located in multiple areas of cooking chamber 506, e.g., below, at the rear, to the side. Separate control valves would allow for independent control of the separate burners for the cooking chamber and for burners, e.g., burners 62, for griddle 30.

In one embodiment, pizza plate inserts 600 (FIGS. 42A, 42B) are provided with dimple design 602 having a plurality of raised members 604 to reduce surface contact and to promote cooking.

In one embodiment, alternate griddle 700 may be used. Alternate griddle surface design 700 is provided with raised dimples 702 and raised searing ridges 704 that may be formed into the surface of griddle 700 to allow searing and pizza cooking options without removable inserts.

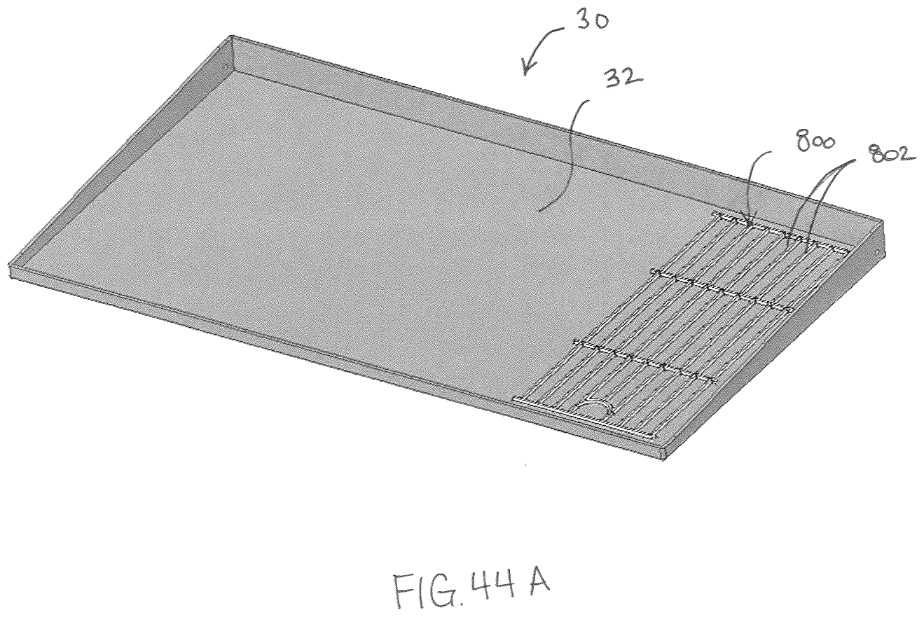

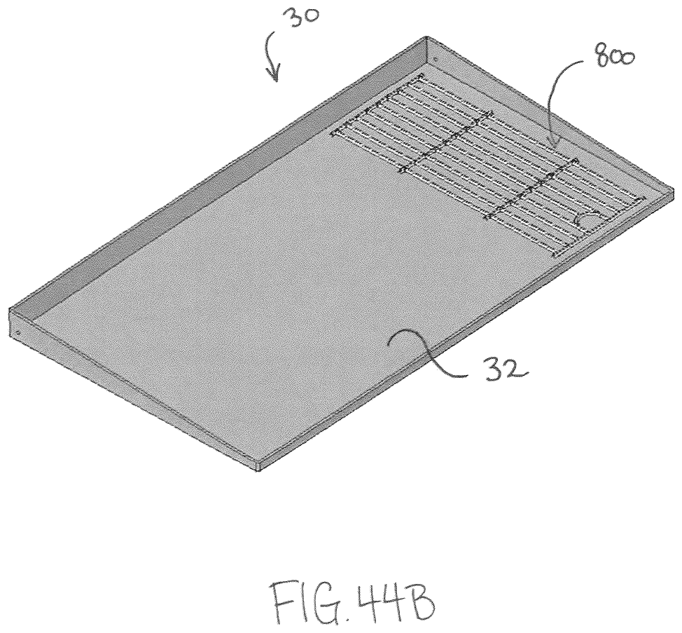

In one embodiment, a cooking grate 800 may be placed directly on griddle surface 32 wherein griddle surface 32 does not have any type of cut-out. Griddle 30 will provide both radiant heating and conductive heating to grate 800 and to food. Grate 800 could be cast iron (as shown) but may also be constructed of other materials, such as porcelain coated wire, stainless steel wire, formed porcelain steel, formed stainless steel, or other materials. In one embodiment, grate 800 is elevated above griddle surface 32 (FIG. 44A), e.g., by cross members 802, and charcoal may be placed directly on griddle 30 for cooking (effectively making griddle 30 a charcoal pan). Preferably, grate 800 is reversible so that a first side is a dedicated charcoal side with integrated grate supports or cross members 802 that would hold grate 800 some distance above the charcoal (FIG. 44A). A second or opposite side of grate 800 is for griddle cooking without the elevated grate supports or cross members 802, thereby placing grate 800 directly on griddle surface 32 (FIG. 44B). The reversible functionality of grate 800 keeps the charcoal use (and charcoal surface residue) on the side that is not used for direct food contact.

The below numbered paragraphs describe possible combinations of elements associated with the invention of the disclosure.
1. A cooking griddle comprises a body having a front surface and a rear surface, a griddle plate supported by the body, the griddle plate defining an upper surface, a versatile section that can be removed, flipped over, or replaced by a secondary cooking member, and a heat source below griddle plate.
2. The cooking griddle according to paragraph 1 wherein the versatile section is the griddle orifice, and the secondary cooking member is a grate sized to be received in the griddle orifice.
3. The cooking griddle according to any of paragraphs 1, 2 wherein the grate is constructed of materials selected from a group consisting of cast iron, porcelain coated wire, stainless steel wire, formed porcelain steel, formed stainless steel, or other materials.
4. The cooking griddle according to any of paragraphs 1-3 wherein the secondary cooling member is a grate adapted to griddle cooking without elevated grate supports or cross members, when placing the grate directly on the upper surface of the griddle plate.
5. The cooking griddle according to any of paragraphs 1-4 wherein the grate is selected from a group consisting of a precision flame IR grate, a cast Q IR grate, a charcoal pan and grate, and a convective grate.
6. The cooking griddle according to any of paragraphs 1-5 wherein the versatile section is the sear griddle orifice, and the secondary cooking member is a rectangular insert for being received in the sear griddle orifice, the rectangular insert selected from a group consisting of a precision flame IR grate, a charcoal pan and grate, a cast Q IR grate, and a convective grate.

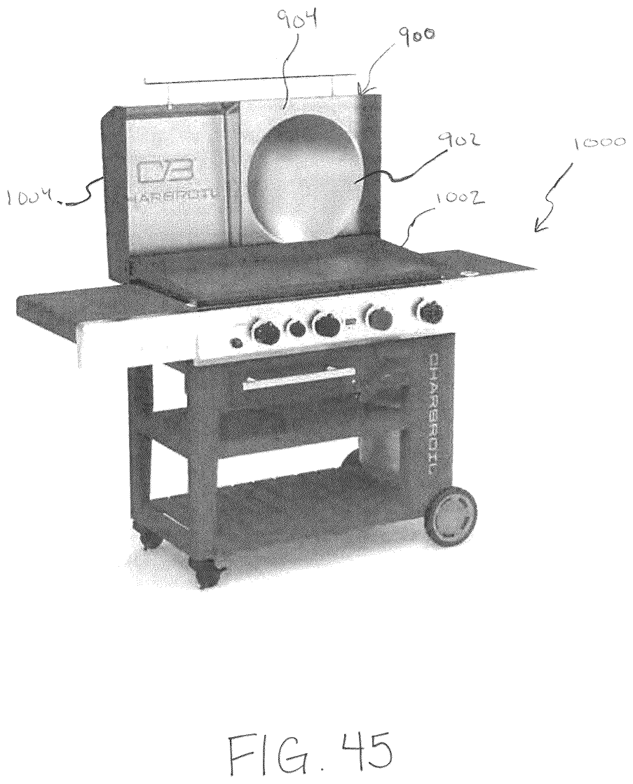

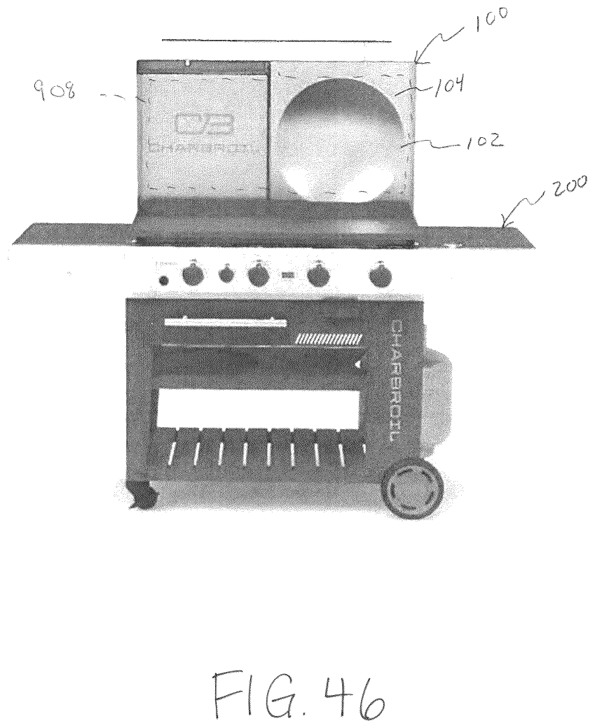

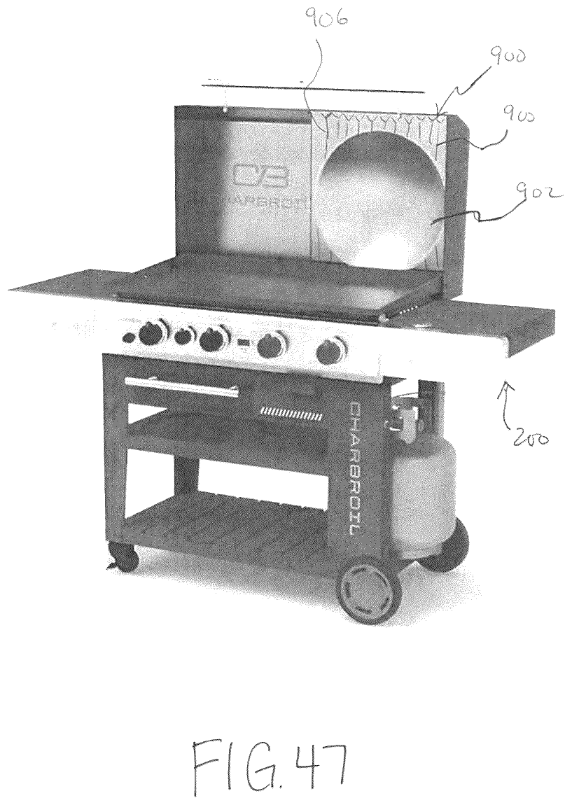

Referring now to FIG. 45 is right perspective view of a domed lid liner 900 installed in a griddle 1000 according to aspects of the present disclosure. FIG. 46 is a front perspective view of the domed lid liner 900 and griddle 1000 of FIG. 45. FIG. 47 is a left perspective view of the domed lid liner 900 and griddle 1000 of FIG. 45.

In various embodiments, domed lid liner 900 has concave cavity 902 that covers and surrounds food placed on a cooking surface 1002 such a griddle or grate. Lid liner 900 is shown installed into a lid 1004 of a gas griddle, i.e., lid liner 900 is affixed to an underside of lid 1004 for being positioned adjacent food items when lid 1004 is moved to a closed position. However, it should be understood that liner 900 can be adapted to be used with a wide variety of cooking devices whether gas, solid fuel, or electrically heated.

The concave or domed area 902 may be situated over a portion of the cooking surface 1002 during use, or may cover the cooking area entirely. In some embodiments, the dome 902 is completely or partially circumscribed by a surrounding surface 904. The surrounding surface 904 may be square or rectilinear in outline, or may have anther shape conform to the lid 1004 and/or cooking surface 1002. The surface 904 may be flat or planar or substantially either. The surface 904 may be textured or smooth. In some embodiments, surface 904 is not entirely flat. The surface 904 may contain ridges or channels, for example, to provide additional control over gas or heat flow or for other reasons.

In some embodiments, the liner 900 is installed or situated in the lid 1004 such that the surface 904 is brought into close proximity to the cooking surface 1002 when the lid 1004 is closed. In some embodiments, the surrounding surface 904 may be brought into contact with the cooking surface 1002 when lid 1004 is closed. In other cases at small gap (e.g., of less than an inch) may remain. In further embodiments, the gap may be larger or smaller.

Bringing the surrounding surface 904 into close proximity to the cooking surface 1002 overcomes limitations of current lid liners to create a smaller, more compact cooking area. Additionally, the concave surface 902 radiates infrared energy perpendicularly to the food placed below thus heating and cooking the top of the food (whereas most outdoor cooking appliances cook the food only or primarily from below). As an example, a pizza placed on the cooking surface 1002 would is be heated from the infrared energy of the domed liner 900 in addition to the heat energy generated by the burners below the cooking surface 1002. In one application, such a configuration functions as a pizza oven. Another advantage is the infusion of a smoke flavor into food by circulating smoke around the food inside the domed cavity formed by domed area 902. Close proximity of the liner 900 to the cooking surface 1002 reduces heat up time as an added benefit.

The liner 900 may be constructed of pressed steel. The liner 900 may comprise stainless steel or another suitable material. In some embodiments, an area between the liner 900 and the lid 1004 is insulated.

The below numbered paragraphs describe possible combinations of elements of a grill configured with domed lid liner 900.
1. A domed lid liner 900 comprising a domed area 902 defining a concave cavity for covering and surrounding a cooking surface 1002 when placed adjacent to the cooking surface 1002.
2. The domed lid liner of paragraph 1 wherein the concave or domed area 902 is situated over a portion of the cooking surface 1002 during use, wherein the concave or domed area 902 covers a cooking area entirely.
3. The domed lid liner of any of paragraphs 1 or 2 wherein the domed area 902 is completely or partially circumscribed by a surrounding surface 904.
4. The domed lid liner of any of paragraphs 1-3 wherein the surrounding surface 904 may be square or rectilinear in outline that conforms the lid 1004 and/or cooking surface 1002.
5. The domed lid liner of any of paragraphs 1-4 wherein the surface 904 is flat or planar or substantially either.
6. The domed lid liner of any of paragraphs 1-5 wherein the surface 904 may define textured elements, e.g., 906 (see, e.g., FIG. 47) or define a smooth surface.
7. The domed lid liner of paragraphs 1-6 wherein the surface 904 is not entirely flat.
8. The domed lid liner of any of paragraphs 1-7 wherein the surface 904 contains ridges or channels, wherein liner 900 is installed or situated in the lid 1004 such that the surface 904 is brought into close proximity to the cooking surface 1002 when said lid 1004 is closed.
9. The domed lid liner of any of paragraphs 1-8 wherein the surrounding surface 904 is brought into contact with the cooking surface 1002 when the lid 1004 is closed.
10. The domed lid liner of any of paragraphs 1-9 wherein a small gap (e.g., of less than an inch) may remain between surface 904 and cooling surface 1002 when lid 1004 is in a closed position.
11. The domed lid liner of any of paragraphs 1-10 wherein positioning the surrounding surface 904 in close proximity to the cooking surface 1002 creates a smaller, more compact cooking area as compared to an area defined by a closed lid 1004 and, therefore, reduces heat up time of a volume under said lid 1004.
12. The domed lid liner of any of paragraphs 1-11 wherein the concave surface 902 radiates infrared energy perpendicularly to food placed below, for heating and cooking a top of the food in addition to heat provided by a heat source below said cooking surface 1002.
13. The domed lid liner of any of paragraphs 1-12 wherein the liner 900 may be constructed of pressed steel or the liner 900 may comprise stainless steel.
14. The domed lid liner of any of paragraphs 1-13 wherein an area between the liner 900 and the lid 1004 is insulated.
15. A lid liner for use with a cooking device that includes a lid 1004 and a cooking surface 1002, the lid liner 900 comprising a domed area 902 affixed with respect to the lid that is placed into proximity with the cooking surface 1002 when the lid 1004 is closed.
16. The lid liner of paragraph 15, further comprising a surrounding surface 904 at least partially circumscribing the domed area 902.
17. The lid liner of any of paragraphs 15-16, wherein the surrounding surface 904 is brought into proximity with the cooking surface 1002 when the lid 1004 is closed.
18. The lid liner of any of paragraphs 15-17, wherein the surrounding surface 904 is planar (see, e.g., FIG. 46).
19. The lid liner of any of paragraphs 1-18, further comprising an insulating layer 908 interposing the domed area 902 and the lid 1004.
20. The lid liner of any of paragraphs 18-19, further comprising an insulating layer 908 interposing the surrounding surface 904 and the lid 1004.
21. The cooking device including a lid liner 900 according to paragraphs 15-20.

Although particular embodiments have been described herein, it will be appreciated that the invention is not limited thereto and that many modifications and additions thereto may be made within the scope of the invention. For example, various combinations of the features of the following dependent claims can be made with the features of the independent claims without departing from the scope of the present invention.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A cooking griddle comprising:
a body having a front surface and a rear surface;
a griddle plate supported by said body, said griddle plate defining an upper surface, a versatile section that can be removed, flipped over, or replaced by a secondary cooking member;
a heat source below griddle plate.

2. The cooking griddle according to claim 1 wherein:
said griddle plate defines a second versatile section;
said second versatile section is a sear griddle orifice.

3. The cooking griddle according to claim 2 wherein:
said secondary cooking member is a sear griddle dual side plate is sized to be received in said sear griddle orifice.

4. The cooking griddle according to claim 1 wherein:
said versatile section of said griddle plate is a griddle orifice.

5. The cooking griddle according to claim 4 wherein:
said griddle plate defines a cutout adjacent to said griddle orifice for providing access for tool insertion to move or flip said secondary cooking member located in said griddle orifice.

6. The cooking griddle according to claim 1 wherein:
said versatile section is a griddle orifice;
said secondary cooking member is a griddle dual side plate sized to be received in said griddle orifice.

7. The cooking griddle according to claim 6 wherein:
said griddle dual side plate defines a first side that is covered with a non-stick coating.

8. The cooking griddle according to claim 6 wherein:
said griddle dual side plate defines a second side that defines dimples or ridges to elevate a food item and to prevent sticking.

9. The cooking griddle according to claim 6, further comprising:
supports below said griddle dual plate, said supports for extending into said griddle orifice for supporting said griddle dual side plate.

10. The cooking griddle according to claim 9 wherein:
said supports are brackets affixed to a bottom surface of said griddle plate for extending into said griddle orifice.

11. The cooking griddle according to claim 9 wherein:
said supports are a circular ring defining an interior shelf.

12. The cooking griddle according to claim 9 wherein:
said supports are an adjustable pivotal bracket for selectively extending into said griddle orifice.

13. The cooking griddle according to claim 9 wherein:
said supports comprise an extendable bracket having a base and an extendable mounted tab for selectively extending into said griddle orifice.

15. The cooking griddle according to claim 6 further comprising:
an elevation mechanism for elevating said griddle dual side plate to an elevated position above said griddle plate for allowing air flow or flue gas circulation around said perimeter of said griddle dual side plate.

16. The cooking griddle according to claim 15 wherein:
said elevation mechanism includes circular elevation ring defining a plurality of downwardly extending elevation tabs.

17. The cooking griddle according to claim 1 wherein:
said secondary cooking member is a plate sized to be received in said versatile section.

18. The cooking griddle according to claim 17 wherein:
said plate is a pizza plate; and
wherein said versatile section is said griddle orifice.

19. The cooking griddle according to claim 17 wherein:
said versatile section is a sear griddle orifice.

20. The cooking griddle according to claim 17 wherein:
said secondary cooking member is a wok sized to be received in said griddle orifice.

21. The cooking griddle according to claim 20 wherein:
wherein said wok is sized to extend below griddle surface when received in said griddle orifice for increasing captured convection.

22. The cooking griddle according to claim 1 wherein:
said section is a sear griddle orifice; and
said secondary cooking member is steamer assembly for being received in said sear griddle orifice.

23. The cooking griddle according to claim 1 wherein:
said secondary cooking member is a perforated surface for allowing flames from a heat source to char food.

24. The cooking griddle according to claim 1, wherein:
said secondary cooking member is a lower profile lid sized to cover a surface of said griddle plate to create an oven for increasing temperature for baking item.

25. The cooking griddle according to claim 1 wherein:
said secondary cooking member is a cooking grate for placing directly on said griddle surface.

26. The cooking griddle according to claim 1 wherein:
said griddle plate provides both radiant heating and conductive heating to said grate and to food on said grate.
